(19) United States
(12) Patent Application Publication
(10) Pub. No.: US 2003/0115142 A1
(43) Pub. Date: Jun. 19, 2003

(54) Identity authentication portfolio system

(75) Inventors: Ernie F. Brickell, Portland, OR (US); Wesley Deklotz, Portland, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/017,835

(22) Filed: Dec. 12, 2001

(51) Int. Cl. G06F 17/60

(52) U.S. Cl. 705/51

(57) ABSTRACT

Systems for providing an authentication service through a number of authentication mechanisms associated with each user. Lists of the authentication mechanisms associated with each user are stored in a set of portfolios, one portfolio for each user. Authentication mechanisms include laptops, PCs, biometric input devices, smart card readers, proximity badge readers, magnetic stripe readers, and the like. The systems have various configurations of registration servers, authentication servers, and authorization servers. Methods for providing an authentication service include relating a user identity to a portfolio, relating a type of transaction to a level of authentication, and authenticating the user identity through one or more authentication mechanisms for the type of transaction, according to the level of authentication required.

### CROSS-REFERENCES

The present application is related to application Ser. No. 09/608,402 filed Jun. 30, 2000, entitled “Digital Credential Usage Reporting,” currently pending (attorney docket number 10559/225001/P8790). The present application is also related to application Ser. No. 09/676,319, filed Sep. 29, 2000, entitled “Managed Authentication Service,” currently pending (attorney docket number 10559/329001/P9832).

### BACKGROUND

Some professionals, such as pharmacists and physicians who have access to secure resources and must protect sensitive client information are reluctant to jump online. Despite the wonders of the Web, its wide accessibility has posed security challenges, especially when it comes to private medical records and prescription drugs.

The growth of online health care services will be dramatic in the next few years, as physicians, hospitals, pharmacists, insurance companies and others move to streamline interactions with each other and with consumers. Effective and affordable user authentication will be a key enabler of this business growth providing the foundation for the high level of privacy and confidentiality that are needed in the health care industry. There is a need for an authentication process that is simple, quick, reliable and flexible enough to authenticate users across complex distributed networks.

Recent federal laws and regulations create considerable complexity for online security for health care services. These include the Health Insurance Portability and Accountability Act of 1996 (HIPA), the Prescription Drug Marketing Act of 1987 (PDMA), and the Electronic Signatures Records in Global and National Commerce Act of 2000 (E-SIGN). Businesses are concerned about creating an environment of trust in which online health care solutions can thrive and in which their potential liabilities are contained. However, it would not be cost efficient for businesses to divert resources from their primary focus to implement complex online security systems. There is a need for an outside provider that can make use of economies of scale to offer authentication services that comply with laws and regulations at a reasonable cost. There is also a need for a provider that offers authentication services to other kinds of industries, such as banking and financial services.

Furthermore, Internet and security technologies are evolving rapidly to meet new business requirements. There is a need for an authentication system that is a flexible open system capable of supporting new technologies as they emerge.

Like other online businesses, health care service providers will need to adapt their content and security procedures to address the requirements of new access devices, such as personal digital assistants (PDAs), cell phones, and other handheld devices. In addition, many personal computers (PCs) and other digital equipment will soon come equipped with fingerprint scanners, iris scanners, and other biometric authentication systems. Additionally, health care service providers often need to provide access to users, such as physicians from many different locations, such as a hospital, an office, and a home computer. There is a need to provide an extensible system to authenticate users in real time wherever they are and with whatever authentication devices are currently available to them.

### DESCRIPTION OF DRAWINGS

FIG. 1 is a block diagram of an example authentication system.

FIG. 2 is a block diagram of an example authentication system for performing registration methods.

FIG. 3 is a block diagram of an example authentication system for performing authorization and authentication methods.

FIG. 4 is a block diagram of an example authentication system for performing registration, authorization, and authentication methods.

FIG. 5 is a flow chart that shows an embodiment of a method of providing an authentication service for systems such as the ones shown in FIGS. 1-4.

FIG. 6 is a flow chart that shows an embodiment of a method of providing an authentication service, which is an alternate embodiment to the one shown in FIG. 5.

FIG. 7 is a flow chart that shows an embodiment of a method of syndication for authentication services, such as the ones shown in FIGS. 5 and 6.

FIG. 8 is a flow chart that shows an embodiment of a method of registration for systems such as the ones shown in FIGS. 1-4.

FIG. 9 is a flow chart that shows an alternative embodiment of the method of registration in FIG. 8.

FIG. 10 is a flow chart that shows an embodiment of a method of authentication for systems such as the ones shown in FIGS. 1-4.

### DESCRIPTION

The present invention provides systems and methods for providing an authentication service, including an identity authentication portfolio system. In the following detailed description, reference is made to the accompanying drawings, which form a part of this application. These drawings show, by way of illustration, specific embodiments in which the invention may be practiced. These embodiments are described in sufficient detail to enable those skilled in the art to practice the invention. Other embodiments may also be used. Structural, logical, and electrical changes may be made without departing from the scope of the present invention.

### Systems

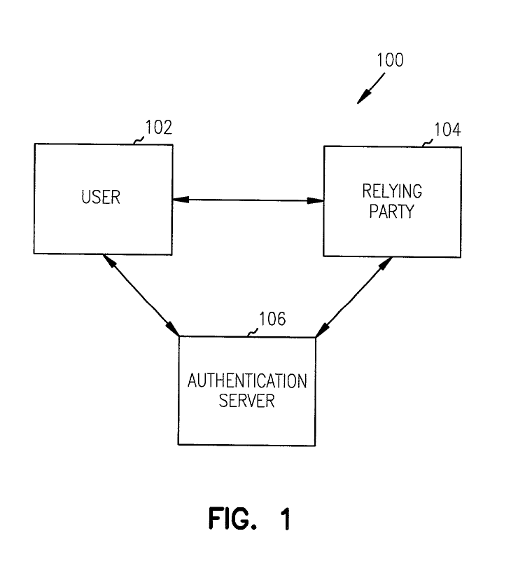

FIG. 1 is a block diagram of an example authentication system 100. The authentication system 100 provides authentication service to a relying party 104 on behalf of a user 102 through an intermediary authentication server 106. A user 102 is any individual that desires access to a service, program, or information provided by a relying party. A relying party 104 is an entity or system relying on the authentication service to authenticate users before it provides access. The authentication server provides authentication service. Authentication service results in the user 102 being granted (or denied) access to a protected service provided by the relying party 104.

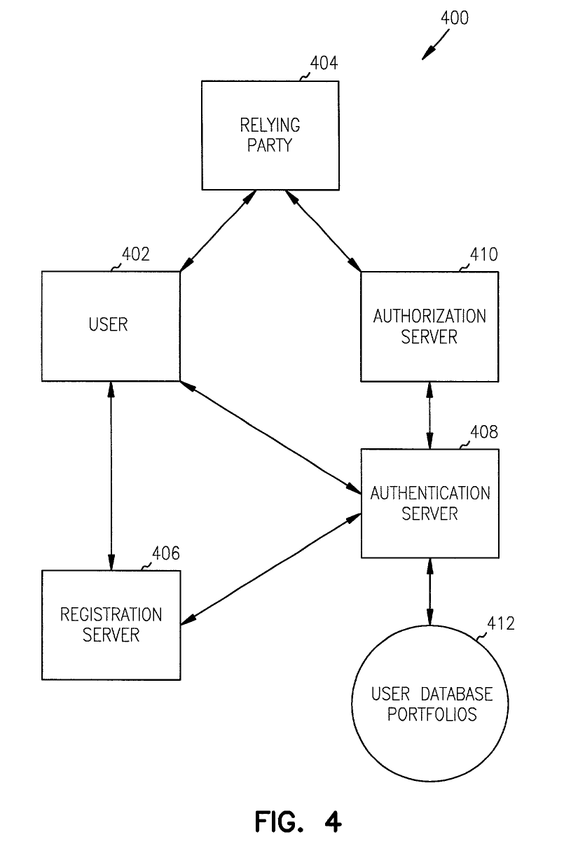

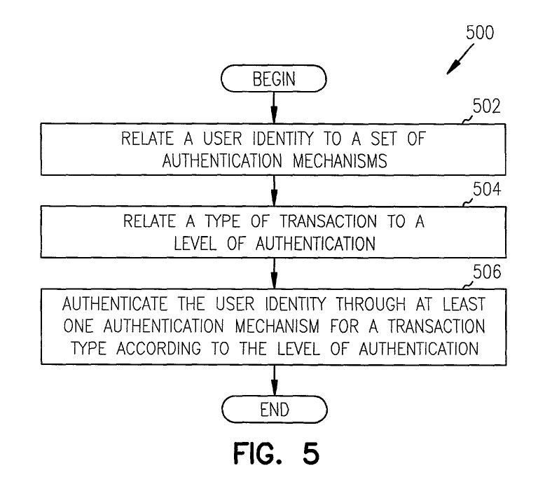

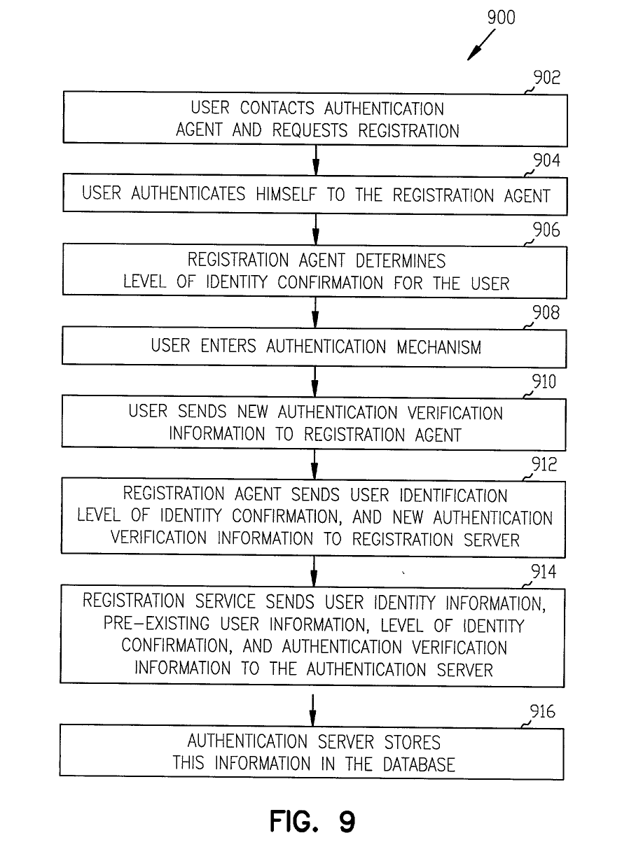

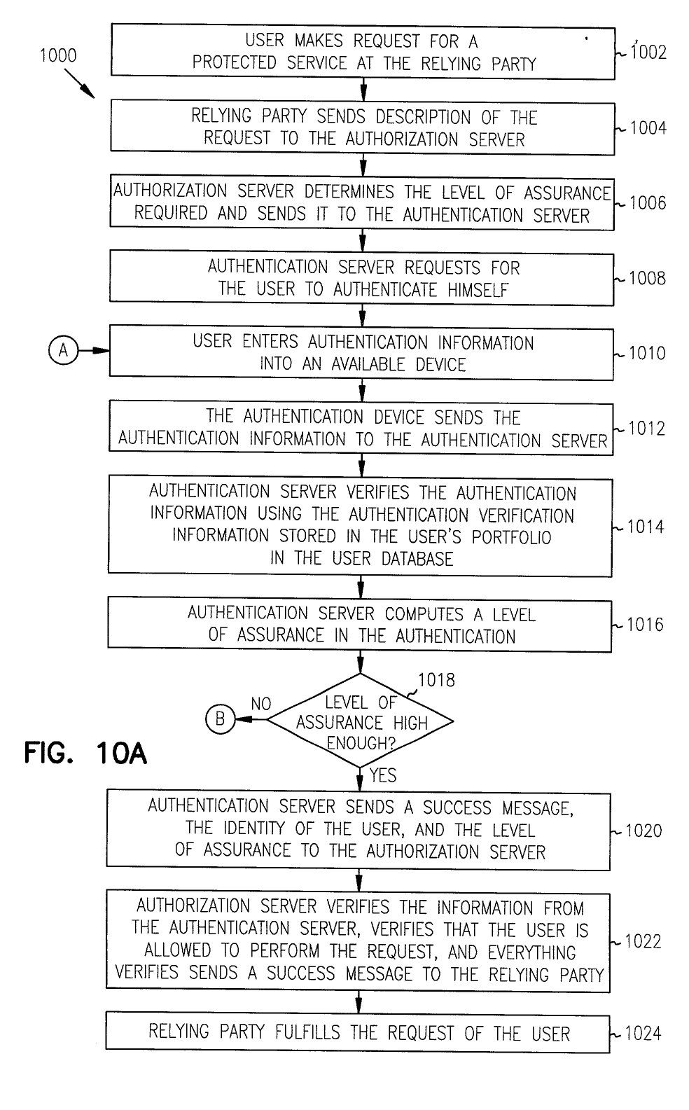

The authentication server 106 provides authentication service by performing registration methods, such as the ones shown in FIGS. 8 and 9 and by performing authentication and authorization methods, such as the ones shown in FIGS. 5-7 and 10. Registration is the process of associating authentication verification information with an individual identity. Authentication is the process of authenticating a user 102 and associating a level of assurance with the authentication of the user 102. Authorization is the process of deciding whether to grant a request to a user 102 based on the request of the user 102, the permissions of the user 102, and the level of assurance provided by the authentication. Registration, authentication, and authorization may all be performed by one server, as shown in FIG. 1, or divided among a number of servers. For example, FIG. 4 shows a registration server, an authentication server, and an authorization server.

Consider a user 102 who wants to buy an item in a store using a credit card. The store is a relying party 104 using an authentication service to process the credit card transaction. To get a credit card, a user 102 first fills out a form applying for it. The credit card company takes the information from the form and processes it to decide whether to open an account for the user 102. That is like registration. After the credit card is sent to the user 102, the user 102 presents the card in the store to buy something. The store clerk requests authentication by asking for a picture ID and comparing the signature on the back of the card to the user's 102 signature. This is similar to authentication. The clerk runs the card through a machine to see if the purchase is approved by the credit card company or not. The credit card company may check if the user's 102 credit limit is exceeded. This is like the authorization. If the purchase is approved, the transaction is completed. This is analogous to access being granted. Embodiments of the present invention provide a system to similarly authenticate a user 102 for an online transaction.

Suppose the user 102 is a doctor and the relying party 104 is an online pharmacy. The online pharmacy uses the authentication system to authenticate each doctor before prescriptions are accepted. The online pharmacy does not accept prescriptions if the doctor is not who he claims to be or if he is not a licensed doctor. When the doctor is hired at a hospital, the hospital registers the doctor for the authentication service. Suppose the doctor has a laptop computer with a fingerprint reader. For that, the doctor chooses a username and password, and submits a sample fingerprint. This is registration. When the doctor submits a prescription to the online pharmacy using a browser on the laptop, the pharmacy automatically invokes the authentication system 100, which authenticates his identity using his username, password, and fingerprint. This is authentication. Then the system verifies he is a licensed doctor. This is authorization. The system notifies the online pharmacy that access is allowed and the prescription is accepted. All of this is seamlessly integrated and the prescription is instantly transmitted. Prescriptions securely transmitted electronically eliminate the need for costly verification caused by illegible handwriting. Embodiments of the present invention provide a simple, quick, reliable and flexible authentication process. This increases trust among relying parties 104, such as pharmacies.

When the user 102 is a doctor and the relying party 104 is a laboratory, the doctor may call up lab results on a wireless handheld Internet device while he and the patient are in the exam room. When the user is a doctor and the relying party is a medical records facility, the doctor may answer a patient's email at his home office computer and then insert the message into the patient's medical record. When the user 102 is a doctor and the relying party 104 is a health insurance company, the doctor may delegate authority to an assistant for claim processing.

Embodiments of the present invention also may be applied outside the health care industry. When the user 102 is an undercover agent and the relying party 104 is the FBI, the undercover agent may obtain a report of criminal activity using a specialized device, after being authenticated by the system. When the user 102 is a broker and the relying party 104 is a stock exchange, the broker may perform financial transactions using a personal computer, after being authenticated by the system. In addition, embodiments of the present invention have many other applications and are not limited to the example applications given in this detailed description. Embodiments of the present invention are intended for use with any authentication system or method regardless of what industry the authentication system or method is applied to.

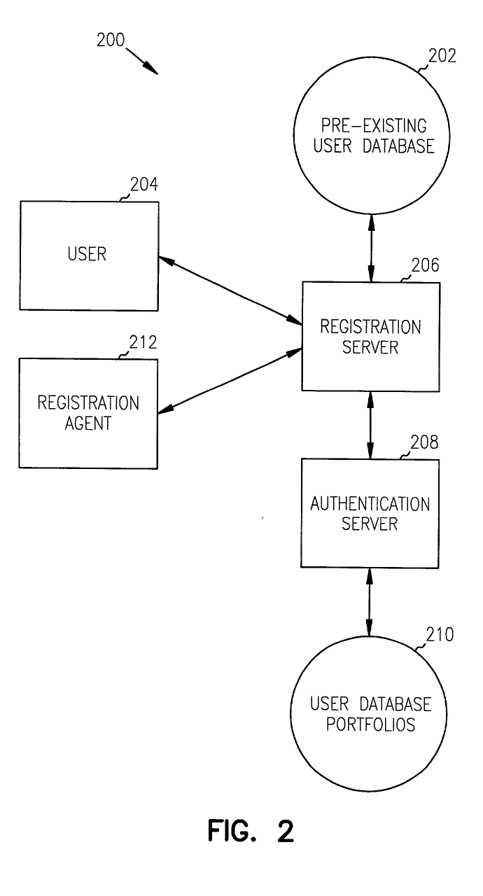

FIG. 2 is a block diagram of an example authentication system 200 for performing registration methods. Registration is the process of associating authentication verification information with an individual identity. Authentication verification information is any information that can be used during authentication to determine whether input from a user 204 is correct. A user 204 must register each authentication mechanism before it is used for authentication. Each user 204 has at least one authentication mechanism associated with their identity.

The collection of authentication mechanisms associated with each user 204 is called a user database portfolio 210 or portfolio for short. The portfolio 210 provides a flexible open system capable of supporting emerging technologies. The portfolio 210 is capable of adopting and extending industry-wide standards to promote interoperability.

After registration, each user 204 may authenticate himself using any of the authentication mechanisms in their portfolio 210. However, authentication mechanisms provide various levels of assurance according to the relative strength of the authentication mechanism. There are many types of authentication mechanisms, including known secrets, biometrics, and stored secrets.

Known secrets include passwords, license numbers, social security numbers, mother's maiden name and the like. Some known secrets are more secret than others. In fact, a password that is used only for one purpose is a much stronger secret than a person's social security number, which is used for many purposes. Sometimes, a known secret is interactive. For instance, when an authentication server 208 poses a question and the user 204 responds to that question. In this case, the information that the user 204 enters in response to the question is the known secret. The authentication server 208 stores the known secret or a result of a computation that depends on the known secret.

A biometric is a measurement of a physical characteristic of a user 204. The physical characteristic is measured by a device or trusted device. The measurement (or a computation that depends on that measurement) is sent from the device through a communications channel to an authentication server 208 for storage. Examples of biometrics include fingerprints, retinas and irises, palm prints, facial structure, voice recognition and any other physical characteristic that can be measured to identify individuals.

Stored secrets include private digital signature keys, which may be password protected, and smart cards. The user's 204 public key is stored by an authentication server 208. Another example of a stored secret is a card that contains a fixed secret. For these cards, the authentication server 208 stores the same secret or the result of some computation that depends upon the secret.

As shown in FIG. 2, during registration, a registration server 206 associates authentication verification information with a user 204 and then communicates that information to an authentication server 208. To make this association, the registration server 206 needs to confirm the identity of the user 204. One way to confirm a user's 204 identity is for the user 204 to initially authenticate using a different authentication mechanism from those authentication mechanisms already registered and stored in the user database portfolios 210. This special initial authentication uses the pre-existing user database 202 to confirm the user's 204 identity. For example, if an authentication server 208 has a pre-existing list of users 204 and their social security numbers stored in the pre-existing user database 202, then a user 204 may initially authenticate themselves by their social security numbers. However, this would be a rather weak form of initial authentication. Another way to confirm a user's 204 identity is for the user 204 to go in person to a registration agent 212. The registration agent 212 would confirm the user's 204 identity through physical means, such as a driver's license and communicate identity confirmation to the registration server 206. During registration, the user 204 provides authentication verification information for one or more new authentication mechanisms. After confirming the user's identity and registering new authentication mechanisms, the registration server 212 sends authentication verification information along with the identity of the user 204 to the authentication server 208.

Another method of registering a user 204 involves sending the user 204 a password. If the authentication server 208 has an address, phone number, or email address for the user 204, the authentication server 208 uses physical mail, phone, or email to send a password to the user 204. Then, the user 204 uses this password as an authentication mechanism, and uses this authentication mechanism to register any other authentication mechanisms.

Any registration process has some potential for compromise. A trusted registration agent 212 could be corrupted. A password communicated through mail, phone, or email could be intercepted. To help mitigate this risk, a registration server 206 determines a level of identity confirmation, which may include performing a combination of the methods described above. For example, suppose that the registration server 206 has a physical mail address and a social security number for each user 204 stored in the pre-existing user database 202. A user 204 initially authenticates himself through a social security number and registers an authentication mechanism. Then, the registration server 206 sends a password to the physical mail address for a higher level of identify confirmation.

Once a user 204 has registered an initial portfolio 210 of authentication mechanisms, he can register additional authentication mechanisms at any time. The user 204 can do this through any of the registration methods given above. For example, the user 204 could authenticate using one of the existing methods, and then add the new method. If the existing methods are all weaker forms of authentication than the new method, the user 204 may go to a registration agent 212 in person to register the new method.

After a user 204 has registered more than one authentication mechanism for his portfolio 210 of authentication mechanisms, he can correlate the authentication mechanisms together by authenticating by multiple methods at the same time.

For example, when a doctor, say Dr. David Ravell, is hired at a hospital, a human resources staff person, acting as registration agent 212, registers the doctor. The hospital obtains information about Dr. Ravell, such as his name, address, and employment number. He may also be given a private password for use only by the registration server 206. This information is then transferred to the registration server 206 and stored in the pre-existing user database 202. To register with the registration server 206, Dr. Ravell would enter his password. Suppose Dr. Ravell wants to register a fingerprint in addition. To do so, he enters a username, password, and a sample fingerprint, which are sent to the registration server 206. The registration server 206 authenticates Dr. Ravell with the password, and adds the fingerprint authentication to his portfolio 210. The registration server 206 sends Dr. Ravell email confirming the new registration. Dr. Ravell also wants to register a handheld computing device he uses when he does his rounds. The handheld computing device has a private-public key pair on it. Dr. Ravell contacts the registration server 206, authenticates with his password, and sends the public key to be added to his portfolio 210. Dr. Ravell also registers public keys stored on his home PC and his office PC. Dr. Ravell additionally registers stored passwords on his two-way pager and cell phone. Dr. Ravell periodically obtains reports indicating all of the authentication methods in his portfolio 210, so he can assure that they are all up to date, and that he is aware of all of them. One year later, Dr. Ravell finds that to use a new highly secure service, he must perform a higher level of identity verification. So, he takes his handheld device and identification papers to a registration agent 212, who identifies him and confirms that the public key on his handheld device is correct and that his fingerprint is correct. This information is sent to the registration server 206, which updates Dr. Ravell's information and sends the information to the authentication server 208. Five years later, Dr. Ravell receives an email message that said the hospital had installed retinal scan devices to secure entry to certain research labs that Dr. Ravell had access to. Dr. Ravell registers for the retinal scan devices by authenticating himself with his password and fingerprint and then submitting a sample retinal scan. He is able to enter the research lab later that day without having had to visit a registration agent. After registration, the doctor may use any and all of these devices during authentication when he performs a transaction, such as sending a prescription to an online pharmacy.

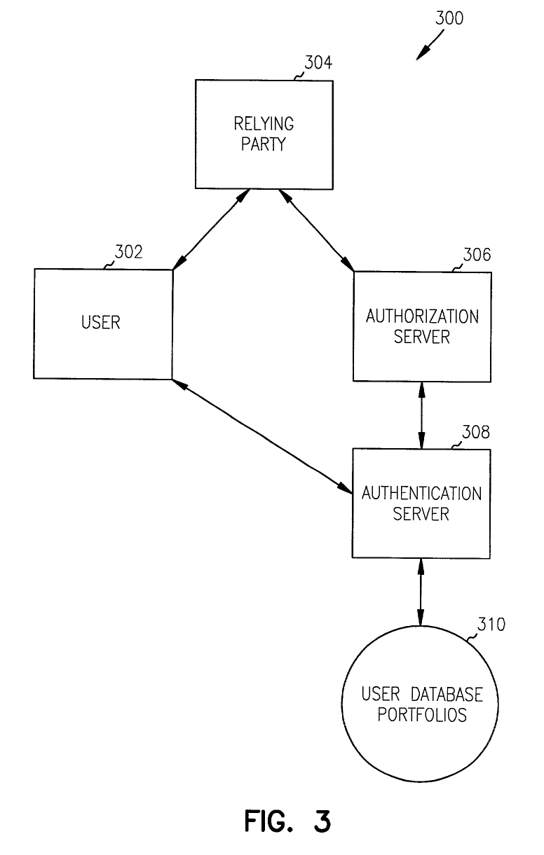

FIG. 3 is a block diagram of an example authentication system 300 for performing authorization and authentication methods. Authentication is initiated when the user 302 requests a service from a relying party 304 that requires authentication. Next, the relying party 304 sends information about the type of transaction that is requested to the authorization server 306. Then, the authorization server 306 determines a level of assurance for the transaction and communicates this to the authentication server 308.

Authentication is a process through which a user 302 (or a device to which the user 302 has access) communicates with the authentication server 308, and the authentication server 308 determines whether or not it is convinced of the identity of the user 302. To confirm the user's 302 identity, the authentication server 308 computes a level of assurance that indicates the degree to which the authentication server is assured of the identity of the user. The authentication server 308 provides the identity and the level of assurance as the output. Alternately, the authentication server 308 provides more detailed information about the authentication method(s) used and the results of the authentication method(s).

To authenticate, the authentication server 308 asks the user 302 to authenticate himself. The user 302 uses one or more authentication mechanisms in his portfolio 310 of authentication mechanisms to authenticate himself. For example, the user 302 enters authentication information into a device. The device performs a computation on this information before sending it to the authentication server 308. This communication is usually secured through encryption. The authentication server 308 optionally performs a further computation using the information sent by the input device and stored authentication verification information to determine whether the user has input the correct authentication input information. In some authentication mechanisms, there are several rounds of communication between the authentication server 308 and the input device before the authentication server 308 determines whether the user has provided the correct authentication input information.

There are many kinds of authentication mechanisms for authentication. For example, the authentication mechanism is a user name and a password, and the input device is a laptop. The authentication mechanism is a question, answer type password, where the user 302 first enters his user name, which is sent to the authentication server 308 by the input device. The authentication server 308 sends a question to the input device, which displays it for the user 302. The user 302 then enters his answer as his password. Passwords, including question/answer type passwords have varying strengths. For instance, the question, “Enter your social security number,” provides some, though not complete, assurance as an authentication mechanism., whereas the question, “What was the name of your best friend in elementary school?” provides a much higher assurance.

A user 302 may have multiple passwords for authentication mechanisms. For example, he may have a password that he uses on a daily routine. He may have another that he has written down and hidden somewhere that he uses occasionally. He may also have one or more question and answer passwords. Because any authentication mechanism is subject to potential compromise or subject to usage problems, the authorization server 306 and the authentication server 308 determine appropriate levels of assurance required for various authentications.

When a user 302 authenticates himself using one or more of the authentication mechanisms in the user's 302 portfolio 310, the authentication server 308 computes a level of assurance for the authentication, based on many factors. These factors include the types of authentication mechanisms used and scores calculated for each of these authentication mechanisms. For example, some authentication mechanisms, such as passwords, give a score of 0 or 1, because either the password is correct or it isn't. Other authentication mechanisms, such as a biometric give a score between 0 and 1, depending on how well the user input data matches the stored data.

Another factor that affects the level of assurance is how an authentication mechanism was registered. A user 302 that was registered through a physical meeting with a trusted registration agent 212 (shown in FIG. 2) gives more assurance than a user 302 that was registered by entering his social security number and date of birth correctly. Another factor that affects the level of assurance is the recent history of the user's 302 account. For example one factor is whether there is any unusual activity by the user 302 and, if there is unusual activity, another factor is how indicative that activity is of fraudulent activity. Unusual activity includes using different authentication methods from those the user normally uses at a given time of day. Unusual activity also includes a user 302 authenticating by using a token and then a short time later, trying to authenticate without a token.

Another factor that affects the level of assurance is how recently the user 302 examined activity reports of his account. Another factor that affects the level of assurance is the long-term history of the account. For example, whether there has been any reported fraud on the account and whether the user has a consistent usage pattern. Another factor that affects the level of assurance is the environment of the input device that the user 302 is using; specifically how secure it is, and whether there has been any recent fraudulent or unusual activity associated with that device. In summary, the level of assurance is computed as a function of all of the factors that the authentication server 308 determines are relevant to the level of assurance.

When a user 302 authenticates himself, the authorization sever 306 specifies the level of assurance in the authentication required for the requested transaction with the relying party 304. The authorization server 306 optionally specifies the function for the authentication server 308 to use to compute the level of assurance. If the user 302 does not meet the level of assurance, then the authentication server 308 requests that the user 302 use an additional authentication mechanism. If the user 302 successfully completes the authentication, then the authentication server 308 reports the identity of the user 302 and the level of assurance to the authorization service 306. The authorization server 306 determines if that user 302 is authorized for the requested transaction with the given level of authentication. If so, the user's 306 request is fulfilled. Otherwise, it is denied.

For example, suppose that the user 302 has the authentication mechanisms listed in Table 1 in his portfolio 310. Each authentication mechanism is assigned a score by the authentication server 308.

TABLE 1
Sample Scores for Authentication Mechanisms

| Authentication mechanism | Score |
|---|---|
| 8 character password | 5 |
| Question and answer password #1 | 5 |
| Question and answer password #2 | 5 |
| Smart Card with private cryptographic key | 8 |
| Fingerprint | 8 |
| Retinal Scan | 9 |

Suppose further that the history on the user's 302 portfolio 310 indicates the events shown in Table 2.

TABLE 2
Sample history

| History event | Score |
|---|---|
| 6 month use with no fraud on any | +2 |
| authentication mechanism | |
| Recent unusual, unverified event | −1 |

Suppose that the user 302 normally authenticates with his smart card, but left it at home. The first time that the user 302 uses his account during this day, he authenticates with his fingerprint. The authentication server 308 allows the authentication, but notes that this is unusual, and thus assigns the user 302 the score of −1 for an unusual event in recent history as shown in Table 2. Suppose now that the user 302 wants access to a relying party 304 that asks for an authentication level of at least 12, and that the user 302 is trying to obtain access from a device that has no biometric attached to it. Thus the only authentication mechanisms available to the user are the password and the two question and answer passwords. The authentication server 308 would inform the user that to obtain the access, he must enter his password and must answer both of the questions correctly. If the user 302 does this, then his total score for this authentication is 5+5+5+2−1=16, which is greater than 12, and thus the user 302 would pass.

In addition to the decision process illustrated in the example, the authorization server 306 optionally specifies the identity confirmation level that is required for the transaction. For example, the user 302 may only use authentication mechanisms that had been registered directly with a registration agent 212.

The user authenticates to the authentication server 308, which then passes the results of the authentication to the authorization server 306. If the level is not sufficient, then the authorization service 306 reports this to the authentication server 308, which then asks the user 302 for authentication through an additional mechanism.

### Methods

FIG. 5 is a flow chart that shows an embodiment of a method of providing an authentication service 500 for systems such as the ones shown in FIGS. 1-4. One aspect of the present invention is a method of providing an authentication service 500. The method 500 comprises relating a user identity to a set of a plurality of authentication mechanisms 502, relating a type of transaction with a relying party to a level of authentication 504, and authenticating the user identity through at least one authentication mechanism in the set of the plurality of authentication mechanisms for the type of transaction, according to the level of authentication 506. A relying party may set the authentication levels required for different types of transactions along a continuum from a low level of authentication to a high level of authentication.

For example, a low level of authentication may be required when Dr. Ravell orders stethoscopes from a medical supply store. On the other hand, a high level of authentication may be required when Dr. Ravell transmits a prescription to an online pharmacy for a large amount of morphine. In the medical supplies example, Dr. Ravell may be able to use a username and password only to be authenticated, while in the morphine prescription example, Dr. Ravell may have to use a username and password as well as a fingerprint scan to be authenticated.

In addition to having different levels of authentication, there are optionally different levels of identity confirmation. For example, there might be four levels of identity confirmation associated with the AMA web site as follows: level 1 (a student Internet ID), level 2 (a professional Internet ID), level 3 (a confirmed Internet ID), and level 4 (a notarized Internet ID). The level 1 confirmation level is for medical students who are attending an accredited U.S. medical school. A student Internet ID is issued online at the AMA web site. Once the AMA receives a graduation report and/or medical licensure, the student can terminate this or her student Internet ID, and apply for a professional Internet ID. The level 2 confirmation level is available to all physicians. A professional Internet ID is issued online at the AMA web site. Physicians input their name, state, zip code, data of birth, social security number, Drug Enforcement Administration (DEA) number, last year of residency, medical license number and state. This information is matched against an AMA physician masterfile. The level 3 confirmation level is an upgrade from level 2. Confirmation for the upgrade takes place over the phone or through the U.S. mail, after a physician requested the upgrade at the AMA web site and entered the zip code for his practice. He enters the address of his practice and the AMA confirms the address and sends a confirmation code to the physician by U.S. mail. The physician then returns to the AMA web site and enters the confirmation code to upgrade. The level 4 confirmation level is an upgrade from level 3. At the AMA web site, a physician selects the upgrade, which generates a printout that includes authentication verification information provided by the physician such as the hash of the physician's public key. The physician has the form notarized and mails it to the AMA. After the form is received and confirmed, the AMA approves the upgrade.

Embodiments of the present invention provide an extensible system to authenticate users in real time wherever they are and with whatever authentication devices are currently available to them. [0045] In another embodiment of the method 500, at least one of the authentication mechanisms is mobile.

In another embodiment, the method 500 further comprises monitoring a series of authentications for the relying party to detect fraud. Embodiments of the present invention may be capable of monitoring and logging every authentication event. This enables the user to monitor and audit authentication events, providing a foundation for enhanced fraud detection. If the authentication service detects something unusual, such as the user authenticating with a different authentication method than they normally use, then the authentication service could point out this unusual occurrence the next time the user authenticated with his usual method. If the user indicated that these were fraudulent transactions, then the authentication method that had been compromised could be revoked, and a new method of that type could be created. This could be done by using an uncompromised authentication method, without a new registration.

Another aspect of the present invention is a computer-readable medium having computer-executable instructions for performing the method 500.

Embodiments of the present invention may also be adapted to be consistent with the requirements of current government regulations. To preserve the integrity of the authentication process and help ensure that relying parties are compliant with emerging government regulations, embodiments of the present invention may continuously monitor all authentication events. Every request for registration and every authentication may be logged and audited. Logs may be systematically monitored and then stored for a period of time, such as three years. Reports may be provided to show a list of all physicians who have securely accessed a relying party's service.

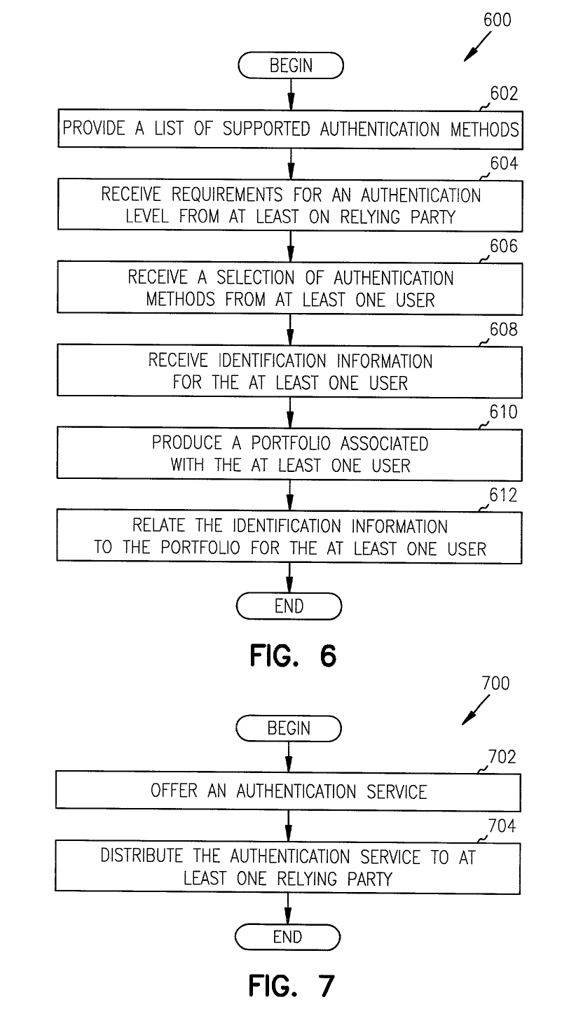

FIG. 6 is a flow chart that shows an embodiment of a method of providing an authentication service, which is an alternate embodiment to the one shown in FIG. 5. One aspect of the present invention is a method of providing an authentication service 600. The method comprises providing a list of supported authentication methods 602, receiving requirements for an authentication level from at least one relying party 604, receiving a selection of authentication methods from at least one user 606, receiving identification information for the at least one user 608, producing a portfolio associated with the at least one user 610, and relating the identification information to the portfolio for the at least one user 612. The portfolio comprises the list of authentication methods. Each authentication method in the portfolio meets the selection of the at least one user. Each authentication method in the portfolio is supported by an authentication system. The list of authentication methods meet the requirements for the authentication level from the at least one relying party.

In one embodiment, the selection is a subset of the list of supported authentication methods. In another embodiment, the method 600 further comprises storing the portfolio on an authentication server capable of providing the authentication service to the at least one relying party. In another embodiment of the method 600, the portfolio includes the authentication information. In another embodiment, the method 600 further comprises providing a selection of authentication methods to the at least one user, receiving at least one selected authentication method from the at least one user, receiving authentication information required to perform authentication for each of the at least one selected authentication methods.

In another embodiment, the method 600 further comprises authenticating, by the authentication system, the at least one user to the at least one relying party. In another embodiment, the at least one relying party is an online pharmacy and the at least one user is a doctor.

In another embodiment, the method 600 further comprises adding a new authentication method to the portfolio. In another embodiment, adding the new authentication method to the portfolio comprises authenticating the at least one user using an authentication method already in the portfolio, receiving authentication information for the new authentication method, and storing the new authentication method and its authentication information in the portfolio.

In another embodiment, the method 600 further comprises receiving notice of a potentially compromised authentication method in the portfolio, authenticating the at least one user using an authentication method already in the portfolio, but not using the potentially compromised authentication method, and revoking the authentication information for the potentially compromised authentication method in the portfolio associated with the at least one user.

In another embodiment, the method 600 further comprises monitoring authentication events for the at least one user, and detecting possible fraud for a suspect authentication method. In another embodiment, the method 600 further comprises authenticating the at least one user using an authentication method already in the portfolio, but not using the suspect authentication method, communicating the possible fraud to the at least one user, upon confirmation of fraud, revoking the suspect authentication method in the portfolio. In another embodiment, the method 600 further comprises automatically revoking the suspect authentication method in the portfolio, wherein the possible fraud is potentially serious fraud. Another aspect of the present invention is a computer-readable medium having computer-executable instructions for performing the method 600.

Suppose Nurse Betty stole Dr. Ravell's username and password and then authenticated herself as him on his office PC. Nurse Betty ordered morphine for herself and overdosed, while Dr. Ravell was checking on the stroke patient. Upon finding Nurse Betty on the floor of his office and learning of the security breach, Dr. Ravell immediately pages for help for Nurse Betty and then uses his cell phone and fingerprint to identify himself so he can re-register his office PC. Later, monitoring reports confirmed that the morphine order was the only transaction made by Nurse Betty pretending to be Dr. Ravell.

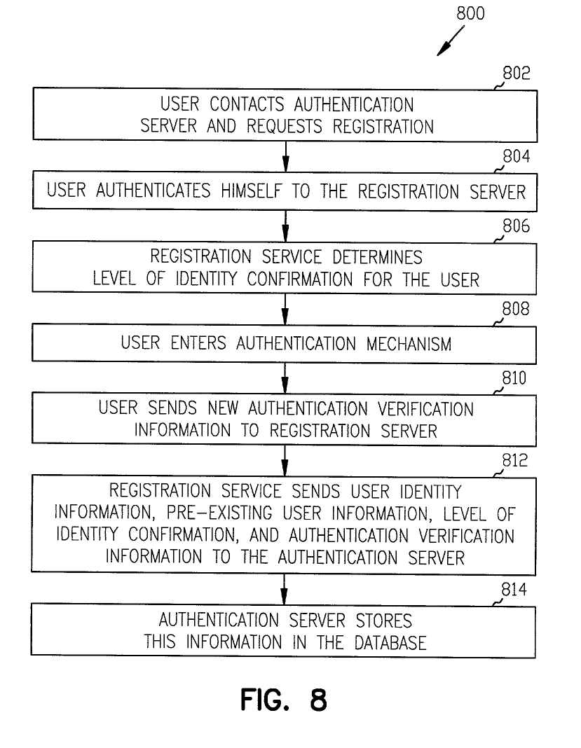

FIG. 7 is a flow chart that shows an embodiment of a method of syndication for authentication services, such as the ones shown in FIGS. 5 and 6. Syndication involves the sale of the same good or service to many customers, who then integrate it with other offerings and redistribute it. A good may be an information good transmitted electronically. Within a syndication network, there are three roles that businesses can play. Originators create original content. Syndicators package that content for distribution, often integrating it with content from other originators. Distributors deliver the content to customers. A company can play one role in a syndication network or it can play two or three roles simultaneously. It can also shift from one role to another over time.

One aspect of the present invention is a method of syndication 700, comprising: offering an authentication service, the authentication service being capable of authenticating a user identity with a plurality of authentication mechanisms, rendering authentication information to at least one relying party, and dynamically making an authorization decision 702, and distributing the authentication service to at least one authentication system 704.

For example, an authentication system could offer and distribute authentication service to medical organizations, such as the AMA, hospitals, medical information providers, pharmacies, insurance companies, and other entities. Embodiments of the present invention make use of economies of scale to offer authentication services at a reasonable cost. Relying parties using the authentication service can focus on their core competencies, knowing that they have a reliable authentication solution that will expand as needed to address next-generation needs and opportunities.

In one embodiment of the method 700, the authentication system integrates the authentication service together with other offerings. In another embodiment, the method 700 further comprises charging the relying party for each authenticating event. In another embodiment, the method further comprises providing secure recovery from potential fraud without requiring re-registration of a user. In another embodiment of the method, the dynamic authorization decision is based on a requested access level, authentication mechanisms used, and an account status. Another aspect of the present invention is a computer-readable medium having computer-executable instructions for performing the method 700.

A benefit of any embodiment of the present invention is that relying parties off load the expense and complexity of authentication, so relying parties can focus on their core competencies and customer relationships. As authentication service evolves, embodiments of the present invention can preserve these advantages. A high level of authentication integrity will be combined with procedures and tools that make it easy for businesses to deploy and administer their authentication services and make it increasingly simply for end-users to obtain secure access to the information and services they need.

FIG. 8 is a flow chart that shows an embodiment of a method of registration 800 for systems such as the ones shown in FIGS. 1-4. FIG. 9 is a flow chart that shows an alternative embodiment 900 of the method of registration in FIG. 8. One aspect of the present invention is a method of registration 800. The method comprises authenticating a user 804, determining a level of identity confirmation for the registration 806, receiving a new authentication mechanism 808, and receiving new authentication verification information 810. The method comprises storing the user identity information, the level of identity confirmation, and the authentication verification information in a database 814.

In one embodiment, authenticating the user 804 is done by a registration server. In another embodiment, authenticating the user 904 is done by a registration agent. In another embodiment, authenticating the user is performed by using an authentication mechanism stored in the database. In another embodiment, the method further comprises receiving a request for registration 802 from the user. In another embodiment, receiving the request for registration is done by an authentication server 802. In another embodiment, receiving the request for registration is done by an authentication agent 902. In another embodiment, determining the level of identity confirmation for the user is done by a registration server 806. In another embodiment, determining the level of identity confirmation for the user is done by a registration agent 906. In another embodiment, receiving new authentication information is done by a registration server 810. In another embodiment, the method 800 further comprises sending user identity information, pre-existing user information, the level of identity confirmation, and authentication verification information 812. In another embodiment, sending is done from a registration server to an authentication server 812. In another embodiment, sending the user identity information, the level of identity confirmation, and the authentication verification information is done from a registration agent to a registration server 912. In another embodiment, the method 800 further comprises sending pre-existing user information.

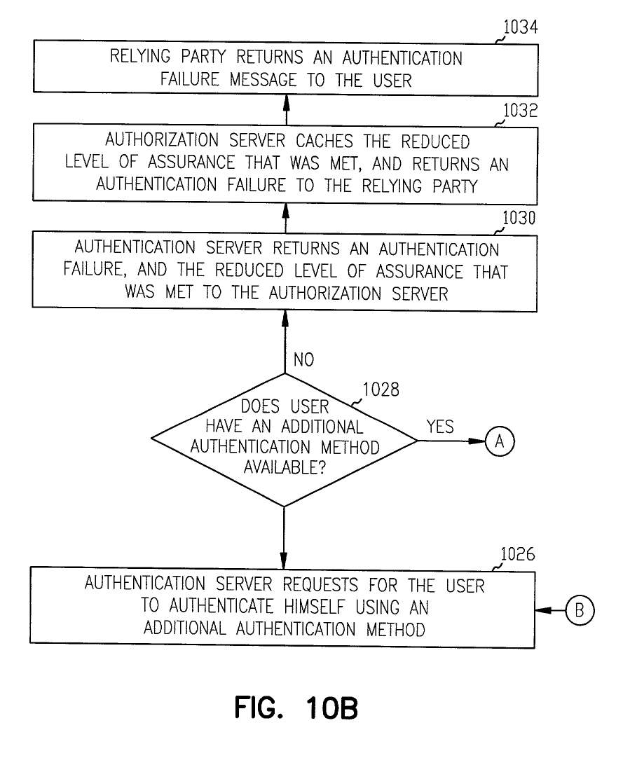

FIG. 10 is a flow chart that shows an embodiment of a method of authentication 1000 for systems such as the ones shown in FIGS. 1-4.40. One aspect of the present invention is a method of authentication 1000. The method 1000 comprises a user requesting a protected service from a relying party 1002. The relying party sends a description of the request to an authorization server 1004. The authorization server determines a first level of assurance and sends the first level of assurance to an authentication server 1006. The authentication server requests authentication from the user 1008. The user enters authentication information into an authentication device 1010. The authentication device sends authentication information to the authentication server 1012. The authentication server verifies the authentication information using authentication verification information stored in a portfolio in a database that is associated with the user 1014. The authentication server computes a second level of assurance 1016. The second level of assurance is evaluated to see if it is high enough 1018. Upon determining the second level of assurance is high enough, the authentication server sends a first success message to the authorization server 1020. The authorization server verifies information from the authentication server and verifies that the user is allowed to perform the protected service and then sends a second success message to the relying party 1022. Upon verification of the information from the authentication server and verification that the user is allowed to perform the protected service, the relying party provides the protected service to the user 1024.

The authentication server determines if the user has an additional authentication method available 1028. In one embodiment, upon determining the second level of assurance is not high enough, the authentication server requests that the user authenticate using at least one additional authentication method 1026. In another embodiment, upon determining the user is unable to authenticate using the at least one additional authentication method, the authentication server sends a first failure message and a reduced level of assurance to the authorization server 1030. The authorization server stores the reduced level of assurance and sends a second failure message to the relying party 1032. The relying party provides a third failure message to the user 1034.

It is to be understood that the above description it is intended to be illustrative, and not restrictive. Many other embodiments will be apparent to those skilled in the art, upon reviewing the above description. The scope of the invention should, therefore, be determined with reference to the appended claims, along with the full scope of equivalents to which such claims are entitled.

What is claimed is:

1. A method of providing an authentication service, comprising:
relating a user identity to a set of a plurality of authentication mechanisms;
relating a type of transaction with a relying party to a level of authentication; and
authenticating the user identity through at least one authentication mechanism in the set of the plurality of authentication mechanisms for the type of transaction, according to the level of authentication.

2. The method as recited in claim 1, further comprising:
selecting the at least one authentication mechanism depending on the plurality of authentication mechanisms related with the user and the level of authentication.

3. The method as recited in claim 1, further comprising:
monitoring a series of authentications for the relying party to detect fraud.

4. The method as recited in claim 1, wherein the authentication mechanisms in the set of authentication mechanisms are part of a distributed system.

5. The method as recited in claim 3, wherein at least one of the authentication mechanisms is mobile.

6. A computer-readable medium having computer-executable instructions for performing the method as recited in claim 1.

7. A method of syndication, comprising:
offering an authentication service, the authentication service being capable of authenticating a user identity with a plurality of authentication mechanisms, rendering results of the authentication to at least one relying party, and dynamically making an authorization decision; and
distributing the authentication service to the at least one relying party.

8. The method as recited in claim 7, wherein the at least one relying party integrates the authentication service together with other offerings.

9. The method as recited in claim 7, wherein the dynamic authorization decision is based on a requested access level, authentication mechanisms used, and an account status.

10. The method as recited in claim 7, further comprising:
providing secure recovery from potential fraud without requiring re-registration of a user.

11. The method as recited in claim 7, further comprising:
charging the relying party for each authenticating event.

12. A computer-readable medium having computer-executable instructions for performing the method as recited in claim 6.

13. A method of registration, comprising:
authenticating a user;
determining a level of identity confirmation for a registration;
receiving a new authentication mechanism;
receiving new authentication verification information; and
storing user identity information, the level of identity confirmation, and the new authentication verification information in a database.

14. The method as recited in claim 13, wherein authenticating the user is done by a registration server.

15. The method as recited in claim 13, wherein authenticating the user is done by a registration agent.

16. The method as recited in claim 13, wherein authenticating the user is performed by using an authentication mechanism stored in the database.

17. The method as recited in claim 13, further comprising:
receiving from the user, a request for registration.

18. The method as recited in claim 17, wherein receiving the request for registration is done by an authentication server.

19. The method as recited in claim 17, wherein receiving the request for registration is done by an authentication agent.

20. The method as recited in claim 13, wherein determining the level of identity confirmation for the registration is done by a registration server.

21. The method as recited in claim 13, wherein determining the level of identity confirmation for the registration is done by a registration agent.

22. The method as recited in claim 13, wherein receiving new authentication verification information is done by a registration server.

23. The method as recited in claim 13, further comprising sending the user identity information, the level of identity confirmation, and the new authentication verification information.

24. The method as recited in claim 23, wherein sending is done from a registration server to an authentication server.

25. The method as recited in claim 23, wherein sending the user identity information, the level of identity confirmation, and the authentication verification information is done from a registration agent to a registration server.

26. The method as recited in claim 23, further comprising sending pre-existing user information.

27. A method of providing an authentication service, comprising:
providing a list of supported authentication methods;
receiving requirements for an authentication level from at least one relying party;
receiving a selection of authentication methods from at least one user;
receiving identification information for the at least one user;
producing a portfolio associated with the at least one user, the portfolio comprising the list of authentication methods, each authentication method in the portfolio meeting the selection of the at least one user, each authentication method in the portfolio supported by an authentication system, the list of authentication methods meeting the requirements for the authentication level from the at least one relying party; and
relating the identification information to the portfolio for the at least one user.

28. The method as recited in claim 27, wherein receiving the selection is a subset of the list of supported authentication methods.

29. The method as recited in claim 27, further comprising:
storing the portfolio on an authentication server capable of providing the authentication service to the at least one relying party.

30. The method as recited in claim 27, further comprising:
providing a selection of authentication methods to the at least one user;
receiving at least one selected authentication method from the at least one user;
receiving authentication information required to perform authentication for each of the at least one selected authentication methods;
wherein the portfolio includes the authentication information.

31. The method as recited in claim 27, further comprising:
authenticating, by the authentication system, the at least one user to the at least one relying party.

32. The method as recited in claim 31, wherein authenticating the at least one user to the at least one relying party comprises:
providing a challenge to the at least one user;
accepting a response to the challenge from the at least one user;
examining the response to the challenge to ensure its authenticity;
comparing authentication information received by the at least one user to the portfolio associated with the at least one user; and
communicating an authentication result to the at least one relying party.

33. The method as recited in claim 27, wherein the at least one relying party is an online pharmacy and the at least one user is a doctor.

34. The method as recited in claim 27, further comprising:
adding a new authentication method to the portfolio.

35. The method as recited in claim 34, wherein adding the new authentication method to the portfolio comprises:
authenticating the at least one user using an authentication method already in the portfolio;
receiving authentication information for the new authentication method; and
storing the new authentication method and its authentication information in the portfolio.

36. The method as recited in claim 27, further comprising:
receiving notice of a potentially compromised authentication method in the portfolio;
authenticating the at least one user using an authentication method already in the portfolio, but not using the potentially compromised authentication method; and
revoking the authentication information for the potentially compromised authentication method in the portfolio associated with the at least one user.

37. The method as recited in claim 27, further comprising:
monitoring authentication events for the at least one user; and
detecting possible fraud for a suspect authentication method.

38. The method as recited in claim 37, further comprising:
authenticating the at least one user using an authentication method already in the portfolio, but not using the suspect authentication method;
communicating the possible fraud to the at least one user; and
upon confirmation of fraud, revoking the suspect authentication method in the portfolio.

39. The method as recited in claim 37, further comprising:
automatically revoking the suspect authentication method in the portfolio;
wherein the possible fraud is potentially serious fraud.

40. A computer-readable medium having computer-executable instructions for performing the method as recited in claim 27.

41. A method of authentication, comprising:
requesting, by a user to a relying party, a protected service;
sending, by the relying party, a description of the request to an authorization server;
determining, by the authorization server, a first level of assurance;
sending, by the authorization server to an authentication server, the first level of assurance;
requesting, by an authentication server, authentication from the user;
entering, by the user, authentication information into an authentication device;
sending, by the authentication device to the authentication server, authentication information;
verifying, by the authentication server, the authentication information using authentication verification information stored in a portfolio in a database that is associated with the user;
computing, by the authentication server, a second level of assurance;
evaluating whether the second level of assurance is high enough;
sending, by the authentication server to the authorization server, a first success message, upon determining the second level of assurance is high enough;
verifying, by the authorization server, information from the authentication server;
verifying, by the authorization server, that the user is allowed to perform the protected service;
sending, by the authorization server to the relying party, a second success message, upon verification of the information from the authentication server and verification that the user is allowed to perform the protected service; and
providing, by the relying party to the user, the protected service.

42. The method as recited in claim 41, further comprising:
requesting, by the authentication server to the user, authentication using at least one additional authentication method, upon determining the second level of assurance is not high enough.

43. The method as recited in claim 42, further comprising:
sending, by the authentication server to the authorization server, a first failure message and a reduced level of assurance, upon determining the user is unable to authenticate using the at least one additional authentication method;
storing, by the authorization server, the reduced level of assurance;
sending, by the authorization server to the relying party, a second failure message; and
providing, by the relying party to the user, a third failure message.
